(19) United States
(12) Patent Application Publication
(10) Pub. No.: US 2003/0071433 A1
(43) Pub. Date: Apr. 17, 2003

(54) Compact, self supporting and folding equipment access assembly

(76) Inventor: George J. Rammer JR., Marlborough, MA (US)

Correspondence Address: Iandiorio & Teska, 260 Bear Hill Road, Waltham, MA, 02451-1018, US

(21) Appl. No.: 10/093,687

(22) Filed: Mar. 8, 2002

Related U.S. Application Data
(60) Provisional application No. 60/328,549, filed on Oct. 11, 2001.

(51) Int. Cl. B60R 3/00

(52) U.S. Cl. 280/163

(57) ABSTRACT

A compact, self-supporting, folding equipment access assembly including a platform including a proximal end and a distal end, a support section extending outwardly from the proximal end of the platform, the support section including a pair of spaced jaws configured to engage the bumper of a military vehicle. A hanging step is hingedly attached to the distal end of the platform, the step deployable to a position extending downward and outward from the platform and also foldable upward to a storage position adjacent the platform.

### PRIORITY CLAIM

This application claims priority of Provisional Application No. 60/328,549 filed Oct. 11, 2001.

### FIELD OF THE INVENTION

This invention relates to a compact, self-supporting, and folding equipment access assembly attachable, in the preferred embodiment, to the bumper of a military vehicle such as the HMMWV vehicle and useful for accessing equipment mounted on the HMMWV vehicle.

### BACKGROUND OF THE INVENTION

Military vehicles such HMMWVs are often fitted with various types of equipment including antennas some components of which can be fairly high off the ground—six to seven feet or more. The rear bumper of the HMMWV vehicle itself is over two feet off the ground. Thus, operating and servicing equipment mounted on the HMMWV vehicle in the field is often difficult especially in light of the fact that HMMWVs are designed to be deployed in difficult terrain—mud, snow, rocky hillsides, and the like. In one example, the feeds and polarization of the antenna mounted on the top of the HMMWV vehicle must be changed by military personnel in the field. Military personnel must also climb onto the top of the HMMWV vehicle to stow and retrieve equipment located thereon. And, when the antenna must be deployed from its stored position or re-oriented manually, a wrench is used to engage a mechanical drive located high off the ground.

Standard ladders and stools have proven unsuitable for operating and servicing HMMWV mounted equipment especially in the field. Such devices are unstable in many different types of terrain such as mud, sand, and snow. Moreover, ladders placed against the HMMWV place the operator too close to the equipment to work effectively and ladders also pose a serious safety problem. Step stools are typically not rugged enough for military applications and, in addition, they are unstable and thus also dangerous.

### SUMMARY OF THE INVENTION

It is therefore an object of this invention to provide an equipment access assembly.

It is a further object of this invention to provide an equipment access assembly useful in connection with HMMWV mounted equipment and also useful in conjunction with other military vehicles and even civilian vehicles.

It is a further object of this invention to provide such an equipment access assembly which is self supporting and which folds compactly for storage.

It is a further object of this invention to provide such an equipment access assembly which is sturdy and which can support six hundred pounds or more safely even though it only weighs about twenty pounds.

It is a further object of this invention to provide such an equipment access assembly which provides easier access to various types of equipment.

It is a further object of this invention to provide such an equipment access assembly which is configured, in one embodiment, to be mounted directly onto the rear bumper of a HMMWV vehicle.

It is a further object of this invention to provide such an equipment access assembly which is easy to manufacture at low cost.

It is a further object of this invention to provide such an equipment access assembly which is ergonomic in design.

The invention results from the realization that a compact, self-supporting, and folding equipment access assembly which is sturdy irrespective of the terrain is effected by a support section which can be mounted directly to the rear bumper of a military vehicle, a platform which extends rearwardly from the support section in a cantilevered manner, and a step which is hingedly attached to the rear of the platform and supported in a cantilevered manner to extend downwardly. In this way, the step and the platform are supported solely by the support section and thus stable and sturdy irrespective of the terrain. In addition, the step is preferably foldable upward over the platform for storage resulting in a compact and lightweight design.

This invention features a compact, self-supporting, folding equipment access assembly comprising a platform including a proximal end and a distal end; a support section extending outwardly from the proximal end of the platform, the support section including a pair of spaced jaws configured to engage the bumper of a military vehicle; and a hanging step hingedly attached to the distal end of the platform, the step deployable to a position extending downward and outward from the platform and also foldable upward to a storage position adjacent the platform.

Preferably, the platform includes a frame supporting a mesh portion thereon and the support section also includes a frame. The jaws are attached to the support section and the jaws may each have a downward facing opening for engaging the upper portion of the bumper. Typically, the step is U-shaped and includes two spaced side members and a lower bar extending between the two spaced side members. The platform may include a downwardly depending stop for the hanging, hingedly attached step.

In another embodiment, the step is not required and the platform includes a proximal end and a distal end and the support section extends outwardly from the proximal end of the platform. The support section typically includes a pair of spaced jaws configured to engage the bumper of a vehicle such that the platform is supported by the support section in a cantilevered manner. When a step is present, it is preferably hingedly attached to the distal end of the platform and deployable to a position extending downward and outward from the platform and also preferably foldable upward to a storage position adjacent the platform.

A compact, self-supporting, folding equipment access assembly, in accordance with this invention, includes a platform including a proximal end and a distal end; a support section extending from the proximal end of the platform supporting the platform in a cantilevered manner; and a step attached to the distal end of the platform, the platform supporting the step in a cantilevered manner.

### BRIEF DESCRIPTION OF THE DRAWINGS

Other objects, features and advantages will occur to those skilled in the art from the following description of a preferred embodiment and the accompanying drawings, in which:

FIG. 1 is schematic view showing the rear of a HMMWV vehicle with an antenna assembly mounted thereon;

FIG. 2 is a view similar to FIG. 1 but now showing the usefulness of the compact, self-supporting, and folding equipment access assembly of the preferred embodiment of the subject invention mounted on the rear bumper of the HMMWV vehicle;

FIG. 3 is a schematic side view of the compact, self-supporting, folding equipment access assembly mounted on the rear bumper of a HMMWV military vehicle;

FIG. 4 is a schematic three dimensional view showing the primary components associated with the preferred embodiment of the equipment access assembly of the subject invention;

FIG. 5 is a top view of the equipment access assembly shown in FIG. 4;

FIG. 6 is a side view of the equipment access assembly shown in FIGS. 4 and 5; and

FIG. 7 is a schematic view of the prototype equipment access assembly in accordance with another embodiment of the subject invention.

### DISCLOSURE OF THE PREFERRED EMBODIMENT

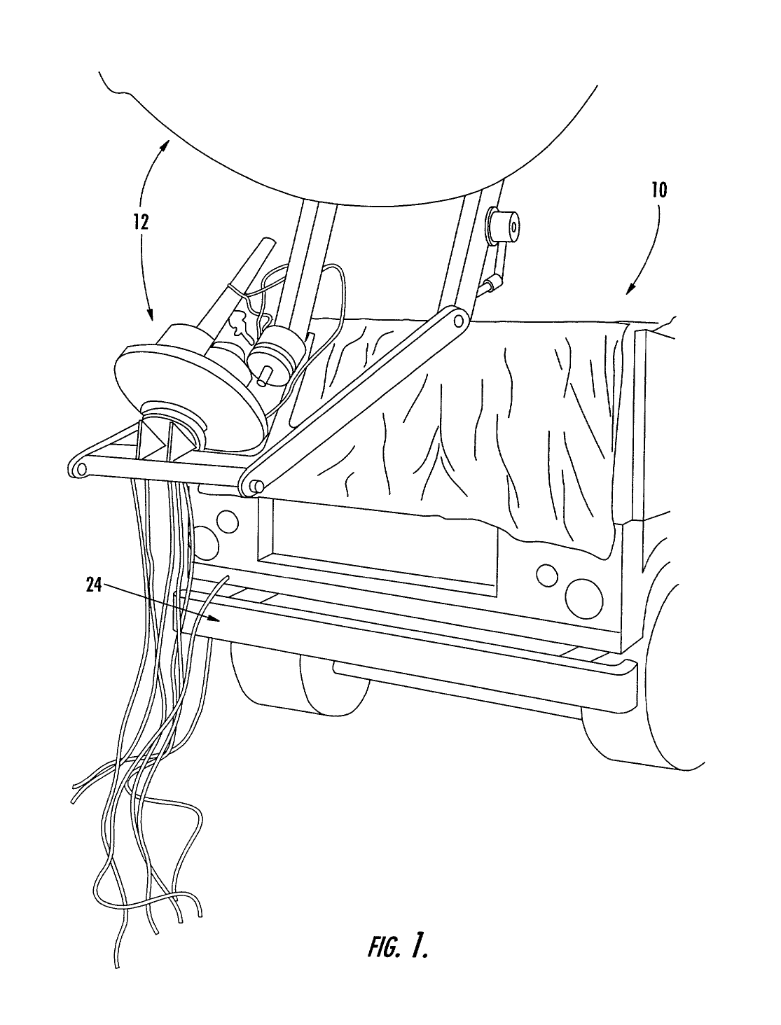

Shown in FIG. 1 is HMMWV vehicle 10 with antenna equipment 12 mounted thereon. As delineated in the Background section above, operating and servicing this equipment in the field is often difficult especially in light of the fact that HMMWVs are designed to be deployed in various types of terrain including mud, snow, and rocky hillsides. In one example, the feeds and polarization of the antenna equipment 12 mounted on the top of HMMWV vehicle 10 must be changed by military personnel in the field. In other examples, military personnel are required to climb onto the top of HMMWV vehicle 10 to stow and retrieve equipment located thereon. And, when the antenna must be deployed from a stored position to the position shown in FIG. 1 or reoriented manually, a wrench is used to turn a manual drive located high off the ground. In this specific non-limiting example, the equipment 12 shown in FIG. 1 including the manual drive is six to seven feet or more off the ground.

As also delineated in the Background section above, standard ladders and stools have proven unsuitable for operating and servicing HMMWV mounted equipment especially in the field. Such devices are unstable in many different types of terrain such as mud, sand, snow, and rocky hillsides. Moreover, ladders placed against the HMMWV vehicle place the operator too close to the equipment to work effectively and ladders also pose a serious safety problem. Step stools are typically not rugged enough for military applications and, in addition, they are unstable and thus also dangerous.

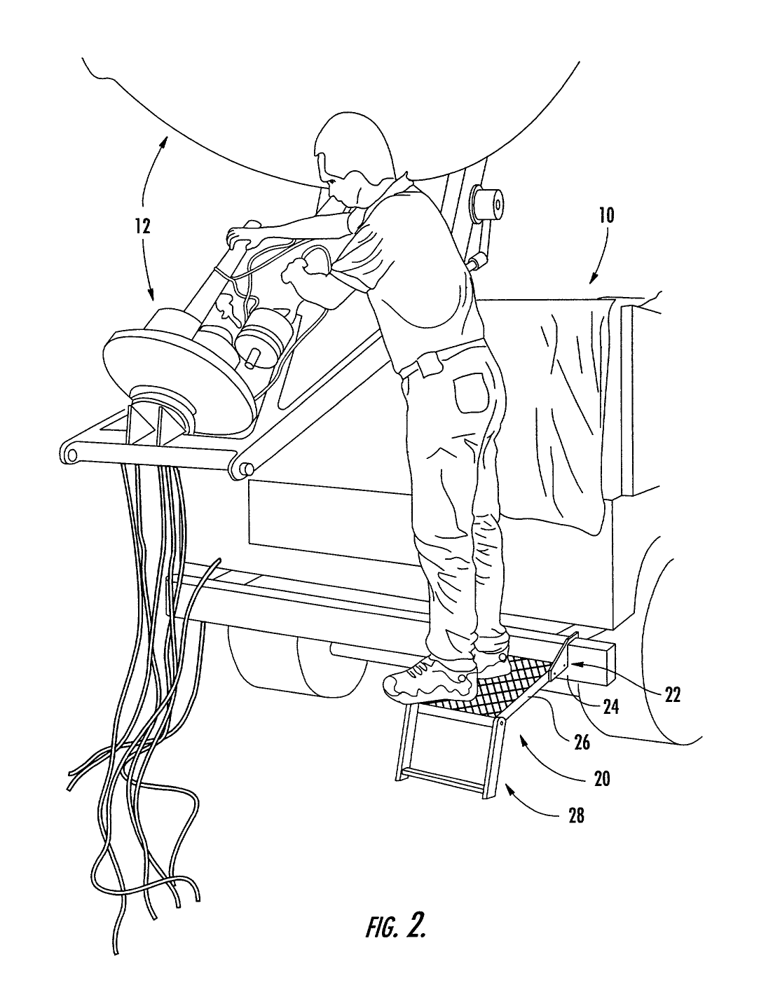

Compact, self-supporting, sturdy and folding equipment access assembly 20, FIG. 2, in the preferred embodiment of this invention, solves the long standing problems associated with ladders and conventional stools especially since assembly 20 is stable irrespective of the terrain and even, to some extent, the pitch or yaw angle of vehicle 10. Support section 22 is shown mounted directly to the rear bumper 24 of vehicle 10. Platform 26 extends rearwardly from support section 22 in a cantilevered manner as shown. Step 28, hingedly attached to platform 26, is also supported in a cantilevered manner. In this way, step 28 and platform 26 are supported solely by support section 22, not the ground, and thus the step and platform are stable and sturdy irrespective of the terrain. In addition, step 28 is foldable upward over platform 26 for storage resulting in a compact and lightweight design.

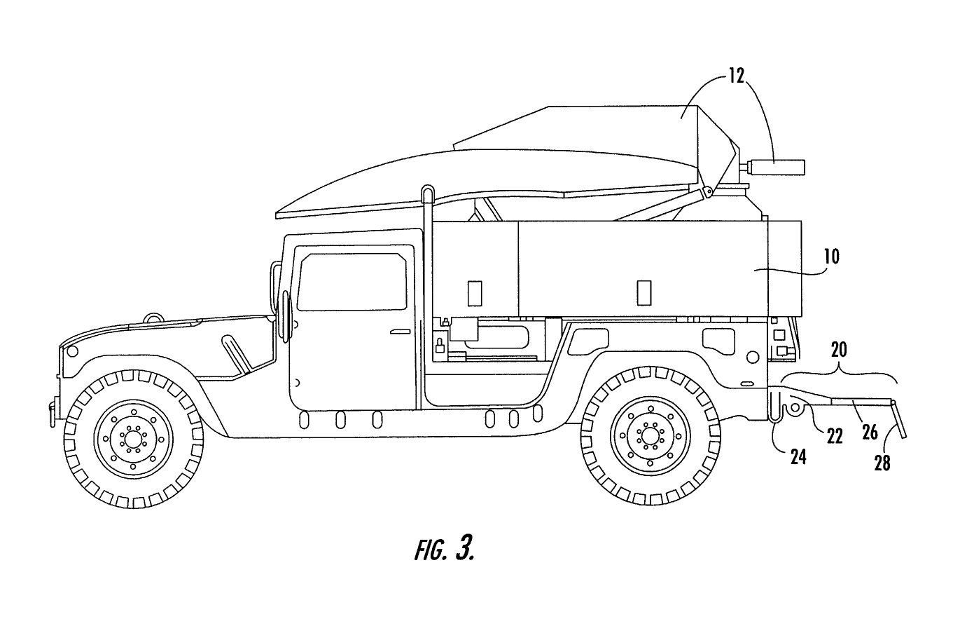

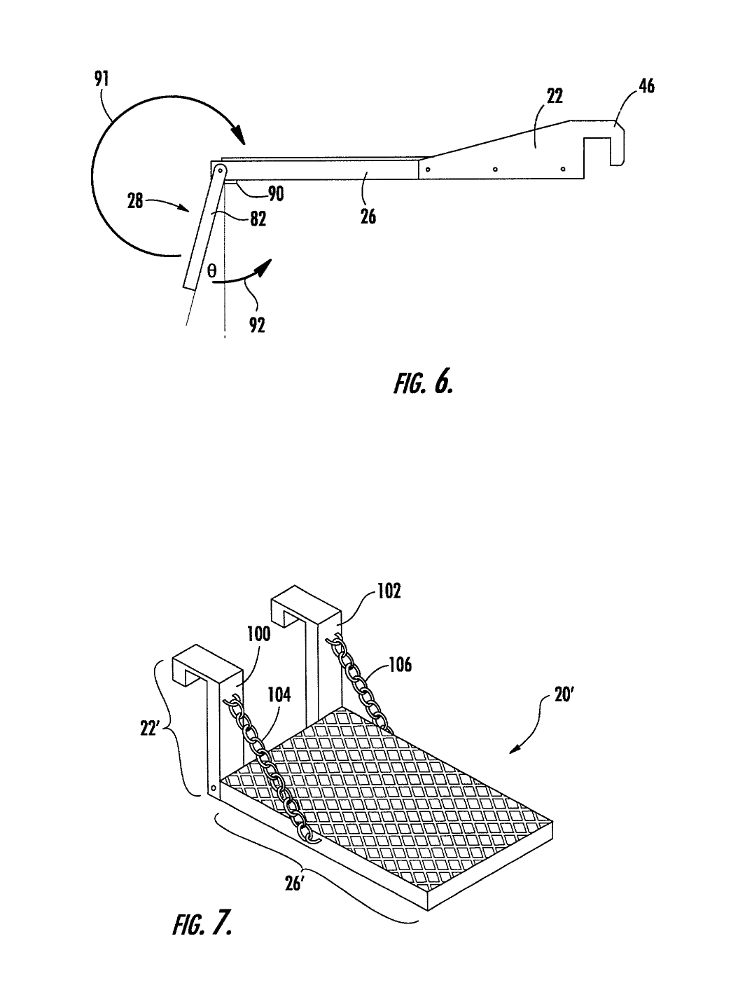

The ergonomic design of assembly 20 is depicted in FIG. 3 where platform 26 positions an operator approximately 26.7 inches off the ground such that a 95^{th} percentile person can more easily access equipment 12 via a stable platform. Equipment 12 was previously unreachable from the ground except with often unwieldy, unstable, and unsafe ladders and stools. Platform 26, FIGS. 4-6 typically includes proximal end 40 and distal end 42. Support section 22 preferably extends outwardly from proximal end 40 of platform 26. Support section 22, in this embodiment, includes a pair of spaced distal jaws 44 and 46 configured to engage the bumper of a military vehicle as discussed infra. Other jaw and support section designs, however, are possible. Hanging step 28 is shown hingedly attached to distal end 42 of platform 26 at hinge 48. Step 28 is deployable to a position extending downward and outward from platform 26 as shown and also foldable upward as shown by vector 50 to a storage position adjacent to or lying on platform 26. Angle θ, FIG. 6, is typically approximately 15°.

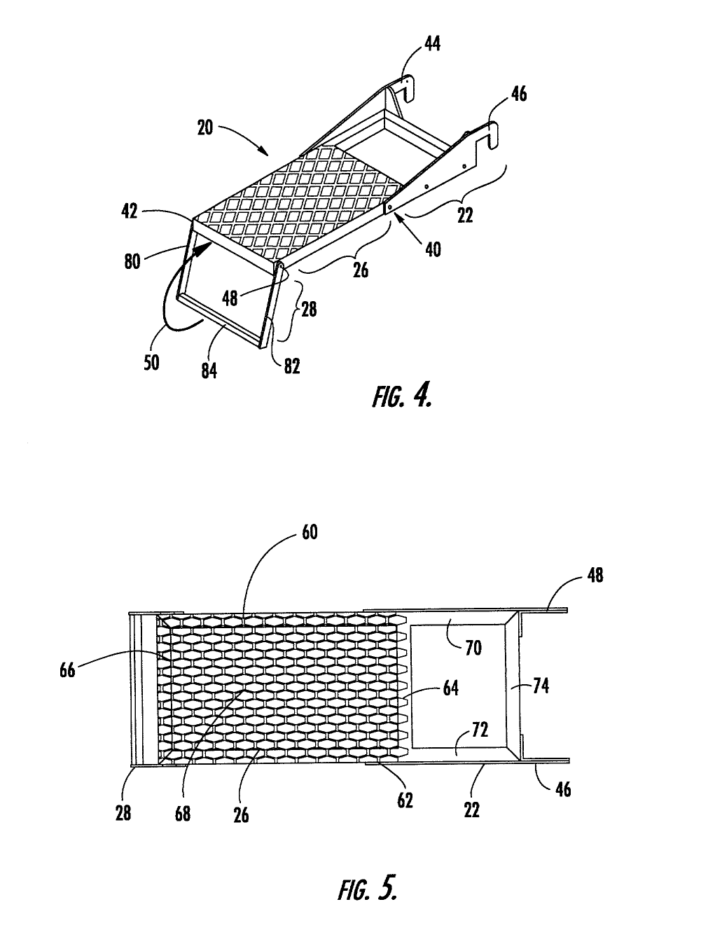

In one example, platform 26 includes a rectangular frame, FIG. 5 with members 60, 62, 64, and 66 supporting ⅛ inch expanded steel wire mesh portion 68 thereon. Mesh is preferred over diamond plate in harsh climates. Support section 22 also preferably includes frame members 64, 70, 72, and 74. Jaw members 46 and 48 are bolted to side frame members 70, 72. All of the frame members 60, 62, 64, 66, 70, 72, and 74 may be made of galvanized expanded steel box tube material 1×1.5−0.084 wall. As shown, frame members 60, 70, and 62, 72 are continuous, 28 inches in length. Members 66, 64, and 74 are 12.38 inches long. Jaws 44 and 46 extend 1.13 inches from cross frame member 74 and upward to a maximum height of 4.5 inches from frame members 60, 62 (13.06 inches from the bottom of step 28). Welding is typically used to join the frame members and metal mesh portion 68 is then welded to the resulting frame. Support jaws 44, 46 are double layers of 0.1875 inch thick steel. Jaws 44, 46 each have a machined downwardly facing opening 2.038 by 2.040 inches for engaging the upper portion of the bumper of a military vehicle such as the HMMWV vehicle. Step 28 is preferably U-shaped and includes two spaced 9.9 inch side members 80, 82, FIG. 4 and lower foot bar or rung 84 extending between side members 80, 82 all welded in construction typically using 1×1×0.093 wall box tube and 1×0.25 inch thick hot rolled steel. Rung 84 is located 16.8 inches off the ground. Step 28 is hinged to platform 26 as shown at hinge member 48 so that step 28 folds in the direction of vector 91 to lie nearly flat on platform 26 for storage. Platform 26 includes downwardly depending stops on each side thereof as shown at 90, FIG. 6 for positioning step 82 at a 15° angle and to prevent free swinging thereof in the direction of vector 92. The entire assembly typically weighs about 20 pounds and yet supports 600 pounds safely. Other dimensions, materials, and configuration will occur to those skilled in the art depending on the various vehicle and/or equipment configurations.

Indeed, in some embodiments, a step may not be required as shown in FIG. 7 where assembly 20′ includes support section 22′ in the form of arms 100, 102 and wire mesh platform 26′ hingedly attached to arms 100, 102 and supported in a horizontal position by chains 104, 106. This prototype design, however, when used in connection with HMMWV vehicle 10, FIGS. 1-3, was not optimal because platform 26′ was 26.7 inches off the ground. Thus, foldable step 28, FIGS. 2-6 is preferred for use with HMMWV class vehicles and any other vehicles with rear bumpers located high off the ground.

Thus, preferably, platform 26, FIGS. 4-6 is rigidly attached to support section 22 extending from the proximal end of platform 26 to support platform 26 in a cantilevered manner and step 28 is hingedly attached to the distal end of platform 26 such that platform 26 supports step 28 via stops 90, FIG. 6 also in a cantilevered manner. The result is a novel equipment access assembly useful for HMMWV, other military vehicles, and also civilian vehicles and which is compact, self-supporting, and which folds for storage and yet it is extremely sturdy and safe irrespective of the terrain. The preferred equipment access assembly of this invention can support 600 pounds or more safely and yet weighs only about 20 pounds, and yet provides easier access to various types of equipment located high off the ground. It is also easy to manufacture at a low cost, and is ergonomic is design.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments.

Other embodiments will occur to those skilled in the art and are within the following claims:

What is claimed is:

1. A compact, self-supporting, folding equipment access assembly comprising:
a platform including a proximal end and a distal end;
a support section extending outwardly from the proximal end of the platform, the support section including a pair of spaced jaws configured to engage the bumper of a military vehicle; and
a hanging step hingedly attached to the distal end of the platform, the step deployable to a stopped position extending downward and outward from the platform and also foldable upward to a storage position adjacent the platform.

2. The assembly of claim 1 in which the platform includes a frame supporting a mesh portion thereon.

3. The assembly of claim 1 in which the support section includes a frame, the jaws being attached to the frame.

4. The assembly of claim 1 in which the jaws each have a downward facing opening for engaging the upper portion of the bumper.

5. The assembly of claim 1 in which the step is U-shaped including two spaced side members and a lower bar extending between the two spaced side members.

6. The assembly of claim 1 in which the platform includes a downwardly depending stop for the hanging, hingedly attached step in the deployed position.

7. A compact, self-supporting equipment access assembly comprising:
a platform including a proximal end and a distal end; and
a support section extending outwardly from the proximal end of the platform, the support section including a pair of spaced jaws configured to engage the bumper of a vehicle such that the platform is supported by the support section in a cantilevered manner.

8. The assembly of claim 7 further including a hanging step hingedly attached to the distal end of the platform, the step deployable to a position extending downward from the platform and also foldable upward to a storage position adjacent the platform.

9. The assembly of claim 7 in which the platform includes a frame supporting a mesh portion thereon.

10. The assembly of claim 7 in which the support section includes a frame, the jaws being attached to the frame.

11. The assembly of claim 7 in which the jaws each have a downward facing opening for engaging the upper portion of the bumper.

12. The assembly of claim 8 in which the step is U-shaped including two spaced side members and a lower bar extending between the two spaced side members.

13. The assembly of claim 8 in which the platform includes a downwardly depending stop for the hanging, hingedly attached step in the deployed position.

14. A compact, self-supporting, folding equipment access assembly comprising:
a platform including a proximal end and a distal end;
a support section extending from the proximal end of the platform supporting the platform in a cantilevered manner; and
a step attached to the distal end of the platform, the platform supporting the step in a cantilevered manner.

15. The assembly of claim 14 in which the platform includes a frame supporting a mesh portion thereon.

16. The assembly of claim 14 in which the support section includes a pair of spaced jaws configured to engage the bumper of a military vehicle.

17. The assembly of claim 16 in which the support section includes a frame, the jaws being attached to the frame.

18. The assembly of claim 16 in which the jaws each have a downward facing opening for engaging the upper portion of the bumper.

19. The assembly of claim 14 in which the step is hingedly attached to the platform, the step deployable to a position extending downward and outward from the frame and also foldable upward to a storage position adjacent the platform.

20. The assembly of claim 1 in which the step is U-shaped including two spaced side members and a lower bar extending between the two spaced side members.

21. The assembly of claim 19 in which the platform includes a downwardly depending stop for the hanging, hingedly attached step in the deployed position.
